(19) United States
(12) Patent Application Publication
(10) Pub. No.: US 2024/0393606 A1
(43) Pub. Date: Nov. 28, 2024

(54) LIGHT SOURCE MODULE

(71) Applicant: TOSHIBA TEC KABUSHIKI KAISHA, Tokyo (JP)

(72) Inventor: Yasushi Kuribayashi, Mishima Shizuoka (JP)

(21) Appl. No.: 18/434,880

(22) Filed: Feb. 7, 2024

(30) Foreign Application Priority Data
May 24, 2023 (JP) 2023-085742

(51) Int. Cl. G02B 27/10; G02B 27/28; H04N 1/028

(52) U.S. Cl. CPC G02B 27/106; G02B 27/283; H04N 1/02825

(57) ABSTRACT

A light source module capable of combining light beams emitted by two semiconductor lasers mounted on the same substrate before entering a collimator lens to be focused on an image plane is provided. The light source module includes the two semiconductor lasers and a light beam combining element. The two semiconductor lasers are arranged so as to have parallel light axes. The light beams emitted by the two semiconductor lasers enter the light beam combining element which emits the light beams with respective light axes made closer to each other. An air conversion length of a total distance from a light emitting surface of one semiconductor laser to an exit surface of the light beam combining element, and an air conversion length of a total distance from a light emitting surface of the other semiconductor laser to the exit surface are equal to each other.

### CROSS-REFERENCE TO RELATED APPLICATION

This application is based upon and claims the benefit of from Japanese Patent Application No. 2023-085742, priority filed on May 24, 2023, the entire contents of which are incorporated herein by reference.

### FIELD

Embodiments described herein relate generally to a light source module to be used in an optical scanning device for installation in an image forming device that can be used in a work place.

### BACKGROUND

In the past, there has been known a light source module having two semiconductor lasers in order to increase a pixel density. In such a light source module, light beams to be emitted by the two semiconductor lasers are combined with each other using a polarization beam splitter.

In the light source module having the two semiconductor lasers, light path lengths from light emitting surfaces of the two semiconductor lasers to the polarization beam splitter are different from each other. Therefore, when attempting to combine the light beams with each other to be focused on an image plane in a stage of the light beam of diverging light before entering a collimator lens, the positions of the light emitting surfaces of the two semiconductor lasers have to be made different from each other. As a result, mounting the two semiconductor lasers on the same substrate is difficult.

### DESCRIPTION OF THE DRAWINGS

FIG. 1 illustrates a vertical cross-sectional view of an image forming device equipped with an optical scanning device having a light source module according to an embodiment.

FIG. 2 illustrates a top view of the optical scanning device.

FIG. 3 illustrates a perspective view of the optical scanning device.

FIG. 4 illustrates a perspective view of the optical scanning device when the light source module is not attached to a housing.

FIG. 5 illustrates a cross-sectional view in which the housing is broken along the line D-D shown in FIG. 2.

FIG. 6 illustrates a perspective view of the light source module.

FIG. 7 illustrates a perspective view of the light source module viewed from an opposite side to that in FIG. 6.

FIG. 8 illustrates a perspective view of the light source module obtained by omitting an illustration of the substrate in FIG. 7.

FIG. 9 illustrates a plan view of the light source module shown in FIG. 6 through FIG. 8.

FIG. 10A illustrates a diagram of a first LD chip in the light source module according to a first practical example viewed in an A direction shown in FIG. 9.

FIG. 10B illustrates a diagram of a second LD chip in the light source module according to the first practical example viewed in a B direction shown in FIG. 9.

FIG. 10C illustrates a diagram showing the first LD chip and the second LD chip so as to overlap each other at light axes.

FIG. 10D illustrates a diagram showing the light source module according to the first practical example with an optical system of the optical scanning device simplified.

FIG. 10E illustrates a plan view showing four converging spots formed on an image plane with the light beams emitted by the two LD chips.

FIG. 11 illustrates a plan view showing the four converging spots actually formed on the image plane with the two light beams emitted by the light source module according to the first practical example fixed to the housing after an angle adjustment.

FIG. 12A illustrates a diagram of a first LD chip in the light source module according to a second practical example viewed in the A direction.

FIG. 12B illustrates a diagram of a second LD chip in the light source module according to the second practical example viewed in the B direction.

FIG. 12C illustrates a diagram showing the first LD chip shown in FIG. 12A and the second LD chip shown in FIG. 12B so as to overlap each other at light axes.

FIG. 12D illustrates a diagram showing the light source module according to the second practical example with an optical system of the optical scanning device simplified.

FIG. 12E illustrates a plan view showing four converging spots formed on an image plane with the light beams emitted by the two LD chips shown in FIG. 12C.

FIG. 13 illustrates a plan view showing the four converging spots actually formed on the image plane with the two light beams emitted by the light source module according to the second practical example fixed to the housing after an angle adjustment.

### DETAILED DESCRIPTION

A problem to be addressed is to provide a light source module capable of combining the light beams emitted by the two semiconductor lasers mounted on the same substrate with each other before entering the collimator lens to be focused on the same image plane.

A light source module according to the embodiment includes first and second semiconductor lasers and a light beam combining element. The first and second semiconductor lasers are arranged so that respective light axes are parallel to each other. First and second light beams respectively emitted by the first and second semiconductor lasers enter the light beam combining element, and the light beam combining element emits the first and second light beams with respective light axes made closer to each other. An air conversion length of a total distance from a first light emitting surface of the first semiconductor laser to an exit surface of the light beam combining element, and an air conversion length of a total distance from a second light emitting surface of the second semiconductor laser to the exit surface of the light beam combining element are equal to each other.

An embodiment will hereinafter be described with reference to the drawings. In each of the drawings used for an explanation of the embodiment, scale sizes of the respective parts are arbitrarily changed in some cases. Further, each of the drawings used for the explanation of the embodiment illustrates while omitting some of the constituents and symbols in some cases for convenience of explanation.

### (Image Forming Device)

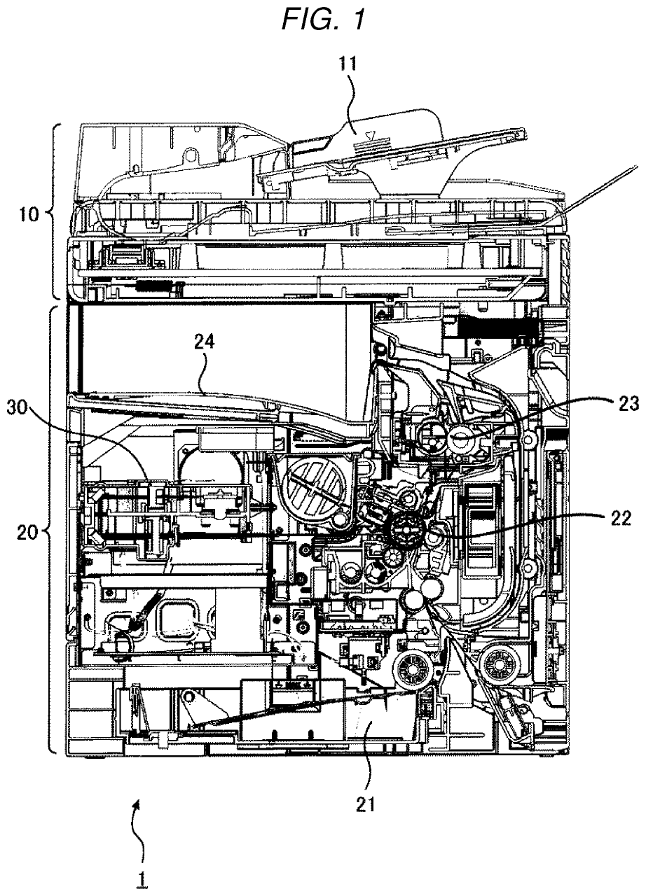

First, an image forming device will be described with reference to FIG. 1. FIG. 1 illustrates a vertical cross-sectional view of the image forming device equipped with an optical scanning device having a light source module according to the embodiment. For example, the image forming device is a multi function peripheral (MFP).

An image forming device 1 is provided with an image reading unit 10 and an image forming unit 20. The image reading unit 10 scans an image of a sheet document or a book document to read the image. The image forming unit 20 forms a developer image on a sheet based on the image read from the document in the image reading unit 10, image data transmitted from external equipment to the image forming device 1, and so on.

The image reading unit 10 is provided with an automatic document feeder (ADF) 11. The image reading unit 10 reads an image of a document conveyed by the automatic document feeder 11 and a document placed on a platen. The image forming unit 20 is provided with a paper cassette 21, a developing unit 22, an optical scanning device 30, a fixing unit 23, and a catch tray 24.

An operation of the image forming unit 20 will be described.

A sheet housed in the paper cassette 21 is conveyed to the developing unit 22 by pickup rollers and conveying rollers. The developing unit 22 forms the developer image on the sheet conveyed from the paper cassette 21. Specifically, first, a photo conductor included in the developing unit 22 is exposed with light from the optical scanning device 30, and thus, an electrostatic latent image is formed on a photo-sensitive surface of the photo conductor.

Then, by supplying the photo conductor with developer, the electrostatic latent image is developed. The developer image is formed on the photo-sensitive surface of the photo conductor, and the developer image on the photo-sensitive surface is transferred to the sheet conveyed from the paper cassette 21. The sheet to which the developer image is transferred is conveyed to the fixing unit 23. The fixing unit 23 heats the sheet to thereby fix the developer image to the sheet. The sheet which passed through the fixing unit 23 is conveyed to the catch tray 24. The sheet which was conveyed from the fixing unit 23 is stacked on the catch tray 24.

A structure of the image forming device 1 shown in FIG. 1 is illustrative only, and can be any structure providing the image forming device 1 is a device capable of forming the developer image on the sheet.

### Optical Scanning Device

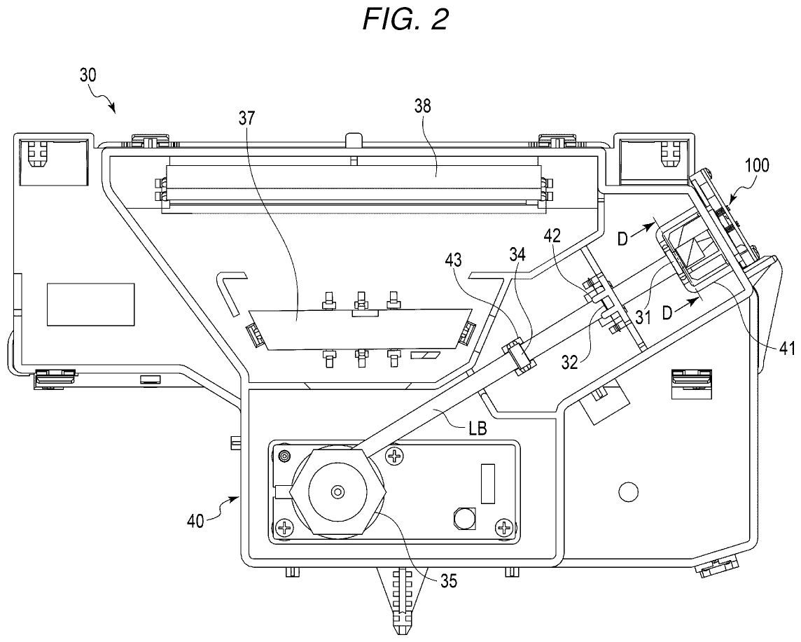

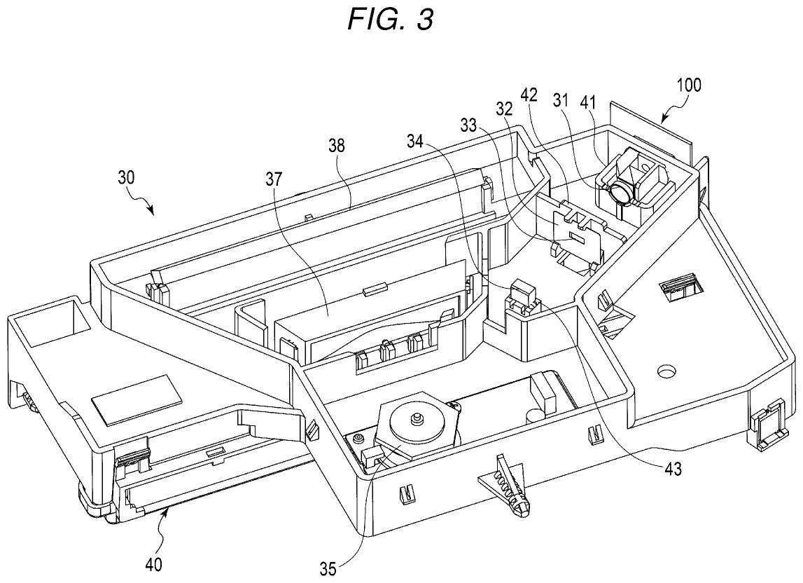

Then, the optical scanning device 30 will be described with reference to FIG. 2 and FIG. 3. FIG. 2 illustrates a top view of the optical scanning device 30 having the light source module according to the embodiment. FIG. 3 illustrates a perspective view of the optical scanning device 30 having the light source module according to the embodiment.

The optical scanning device 30 is provided with a light source module 100. The light source module 100 emits a light beam of diverging light. The details of the light source module 100 will be described later. The light source module 100 is attached to a housing 40 so as to be able to rotate around an optical axis of the light source module 100, and is fixed to the housing 40 after an adjustment of a rotational angle. Here, the optical axis of the light source module 100 means an axis coinciding with a principal ray of the light beam emitted from the light source module 100.

Further, the optical scanning device 30 is provided with a collimator lens 31, an aperture plate 32, a cylindrical lens 34, a polygon mirror 35, an fθ lens 37, and a folding mirror 38. The collimator lens 31, the aperture plate 32, the cylindrical lens 34, the polygon mirror 35, the fθ lens 37, and the folding mirror 38 are all fixed to the housing 40.

The light beam emitted from the light source module 100 enters the collimator lens 31. The collimator lens 31 converts the light beam of the diverging light emitted from the light source module 100 into a light beam LB of parallel light.

As described above, the collimator lens 31 is fixed to the housing 40. Therefore, the housing 40 has a lens holder 41. The lens holder 41 holds the collimator lens 31 so that the central axis of the collimator lens 31 is located on the optical axis of the light source module 100.

The light beam LB which passed through the collimator lens 31 enters the aperture plate 32. As shown in FIG. 3, the aperture plate 32 has an opening part 33 for forming a shape of the light beam LB. The aperture plate 32 transmits light which enters the opening part 33 out of the light beam LB from the collimator lens 31, and blocks light which fails to enter the opening part 33 out of the light beam LB.

As described above, the aperture plate 32 is fixed to the housing 40. Therefore, the housing 40 has an aperture holder 42. The aperture holder 42 holds the aperture plate 32 so that the center of the opening part 33 is located on the optical axis of the light source module 100.

The light beam LB which passed through the opening part 33 of the aperture plate 32 enters the cylindrical lens 34. The cylindrical lens 34 condenses the light beam LB from the aperture plate 32 in a sub-scanning direction. Here, the sub-scanning direction is a direction perpendicular to a main scanning direction. The main scanning direction corresponds to a horizontal direction in FIG. 2. In other words, the sub-scanning direction is a direction perpendicular to the sheet of FIG. 2.

As described above, the cylindrical lens 34 is fixed to the housing 40. Therefore, the housing 40 has a lens holder 43. The lens holder 43 holds the cylindrical lens 34 so that the center of the cylindrical lens 34 is located on the optical axis of the light source module 100.

The light beam LB which passed through the aperture plate 32 enters the polygon mirror 35. The polygon mirror 35 is fixed to the housing 40. The polygon mirror 35 is rotatable, and has a plurality of reflecting surfaces on an outer circumference centering on a rotational axis. The polygon mirror 35 reflects the light beam LB from the aperture plate 32 toward the fθ lens 37. Further, the polygon mirror 35 rotates to thereby perform scanning with the light beam LB in the main scanning direction.

The light beam LB reflected by the polygon mirror 35 enters the fθ lens 37. The fθ lens 37 is fixed to the housing 40. The fθ lens 37 extends in the main scanning direction, and condenses the light beam LB from the polygon mirror 35 in the sub-scanning direction.

The light beam LB which passed through the fθ lens 37 is reflected by the folding mirror 38, and then passes through a cover glass to proceed toward the photo conductor in the developing unit 22 as illustrated in FIG. 1. The light beam LB forms a converging spot on a surface of the photo conductor due to converging functions of the cylindrical lens 34 and the fθ lens 37. A surface of the photo conductor is scanned in the main scanning direction with the converging spot of the light beam LB due to a scanning action of the polygon mirror 35.

### (Light Source Module)

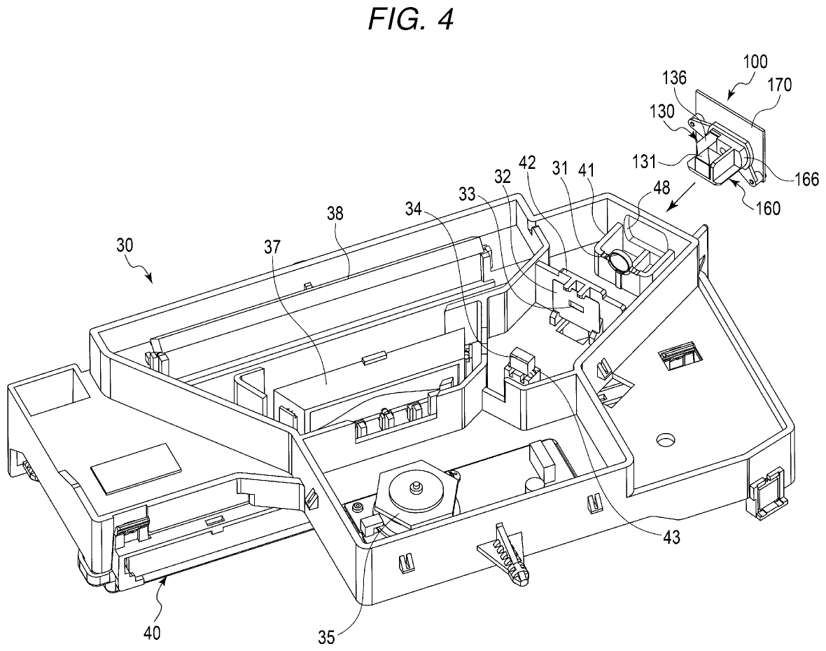

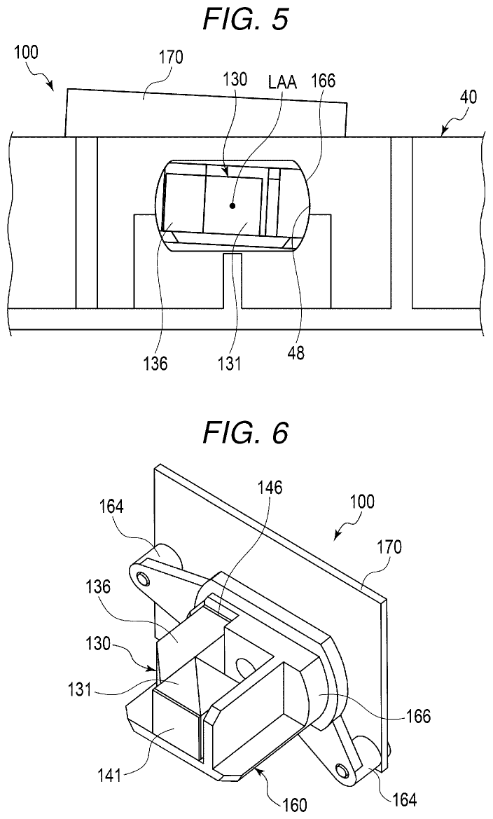

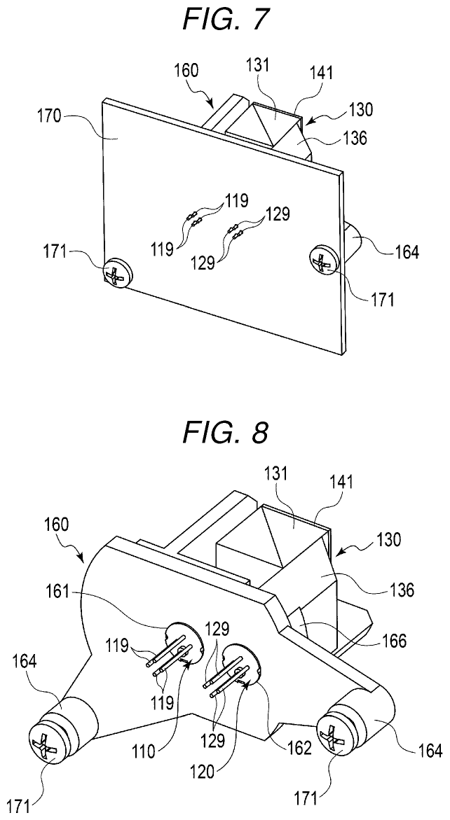

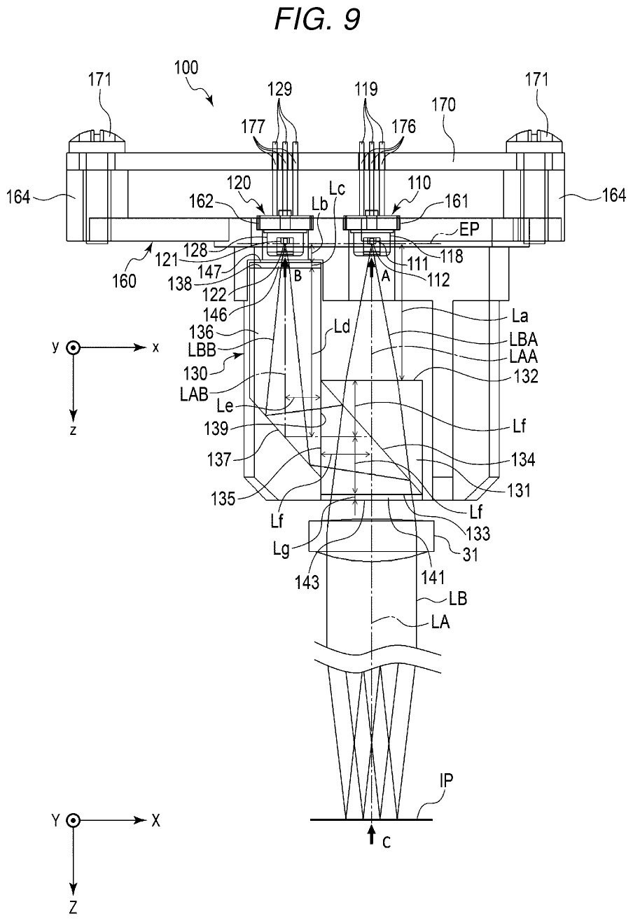

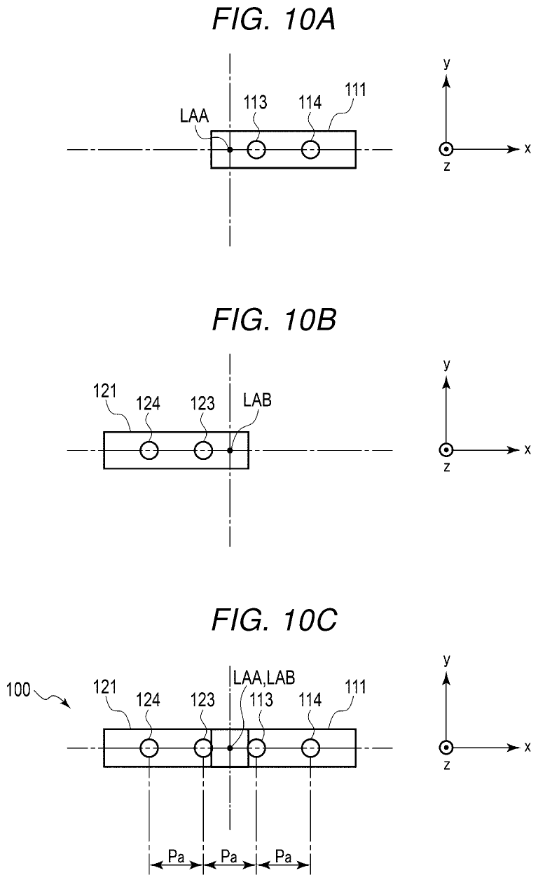

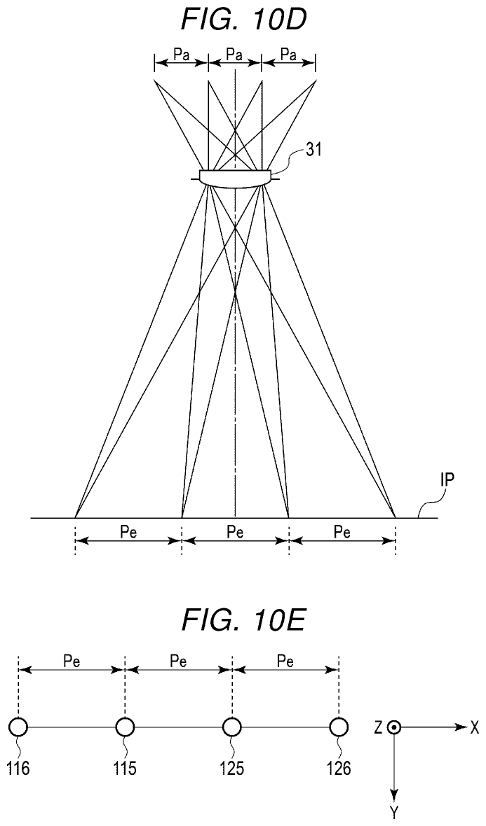

Then, the light source module 100 will be described with reference to FIG. 4 through FIG. 9. FIG. 4 illustrates a perspective view of the optical scanning device 30 when the light source module 100 according to the embodiment is not attached to the housing 40. FIG. 5 illustrates a cross-sectional view in which the housing 40 is broken along the line D-D shown in FIG. 2. FIG. 6 illustrates a perspective view of the light source module 100 according to the embodiment. FIG. 7 illustrates a perspective view of the light source module 100 viewed from an opposite side to that in FIG. 6. FIG. 8 illustrates a perspective view of the light source module 100 obtained by omitting an illustration of the substrate in FIG. 7. FIG. 9 illustrates a plan view of the light source module 100 shown in FIG. 6 through FIG. 8.

First, the light source module 100 will be described in detail with reference to FIG. 6 through FIG. 9. The configuration of the light source module 100 is illustrated in the most detail in FIG. 9, and descriptions of symbols will arbitrarily be omitted in FIG. 4 through FIG. 8 giving priority to eye-friendliness. FIG. 9 also illustrates the collimator lens 31 and an image plane IP in addition to the light source module 100. The image plane IP is a plane on which the light beam LB is converged by the optical system of the optical scanning device 30, and corresponds to the surface of the photo conductor included in the developing unit 22. The surface of the photo conductor is a cylindrical surface in a precise sense, but since the converging spot of the light beam LB is extremely small, the curvature of the surface of the photo conductor can substantively be ignored, and therefore, the surface of the photo conductor is assumed here as a plane for the sake of convenience.

Here, for the sake of convenience of explanation, an x-y-z orthogonal coordinate system is defined with respect to the light source module 100, and an X-Y-Z orthogonal coordinate system is defined with respect to the image plane IP as illustrated in FIG. 9. In the x-y-z orthogonal coordinate system, a z-x plane is parallel to the sheet of FIG. 9, and in the X-Y-Z orthogonal coordinate system, a Z-X plane is parallel to the sheet of FIG. 9. Further, a z axis is parallel to a light axis LAA and a light axis LAB. An optical axis LA is an optical axis of the optical system of the optical scanning device 30, but is described as a straight line in FIG. 9 in a simplified manner. Further, scanning with the optical axis LA is performed along the X axis as the main scanning direction, but in FIG. 9, the optical axis LA is drawn at the central position of the main scanning perpendicular to the image plane IP.

The light source module 100 has a first semiconductor laser 110 for emitting a first light beam LBA, a second semiconductor laser 120 for emitting a second light beam LBB, a holder 160 for holding the first semiconductor laser 110 and the second semiconductor laser 120, and a substrate 170 which includes a drive circuit for the first semiconductor laser 110 and the second semiconductor laser 120 and so on.

The first semiconductor laser 110 has a first LD chip 111, and the second semiconductor laser 120 has a second LD chip 121. It should be noted that the term LD means a laser diode. The first LD chip 111 has a first light emitting surface 112, and the second LD chip 121 has a second light emitting surface 122. The first LD chip 111 emits the first light beam LBA from the first light emitting surface 112 perpendicularly to the first light emitting surface 112, and the second LD chip 121 emits the second light beam LBB from the second light emitting surface 122 perpendicularly to the second light emitting surface 122. The first light beam LBA and the second light beam LBB are both light beams as diverging light. The first LD chip 111 is encapsulated with a first CAN package 118, and the second LD chip 121 is encapsulated with a second CAN package 128. First coupling terminals 119 extend from the first CAN package 118, and second coupling terminals 129 extend from the second CAN package 128.

The holder 160 has a first hole 161 for housing the first semiconductor laser 110, and a second hole 162 for housing the second semiconductor laser 120. The first CAN package 118 of the first semiconductor laser 110 is housed in the first hole 161 of the holder 160, and the second CAN package 128 of the second semiconductor laser 120 is housed in the second hole 162 of the holder 160. Further, the holder 160 has two spacer parts 164. The number of the spacer parts 164 is not limited to two, and can be three or more.

The substrate 170 is fixed to the spacer parts 164 of the holder 160 with screws 171. The substrate 170 has first through holes 176 which the first coupling terminals 119 of the first semiconductor laser 110 pass through, and second through holes 177 which the second coupling terminals 129 of the second semiconductor laser 120 pass through. The first coupling terminals 119 of the first semiconductor laser 110 extend penetrating the first through holes 176 of the substrate 170, and the second coupling terminals 129 of the second semiconductor laser 120 extend penetrating the second through holes 177 of the substrate 170. The first coupling terminals 119 and the second coupling terminals 129 are electrically coupled, and at the same time fixed, to the substrate 170 with soldering after positioning the first semiconductor laser 110 and the second semiconductor laser 120.

The first semiconductor laser 110 and the second semiconductor laser 120 are fixed to the holder 160 so that the respective light axes LAA, LAB are made substantially parallel to each other. Here, the light axis LAA is substantially perpendicular to the first light emitting surface 112 of the first LD chip 111 of the first semiconductor laser 110, and the light axis LAB is substantially perpendicular to the second light emitting surface 122 of the second LD chip 121 of the second semiconductor laser 120. In other words, the light axis LAA and the light axis LAB are both substantially parallel to the z axis.

A light beam combining element 130 will be described. The first light beam LBA emitted from the first semiconductor laser 110 and the second light beam LBB emitted from the second semiconductor laser 120 enter the light beam combining element 130. The light beam combining element 130 emits the first light beam LBA and the second light beam LBB while making the light axis LAA of the first light beam LBA and the light axis LAB of the second light beam LBB closer to each other.

The light beam combining element 130 has a cube-type polarization beam splitter 131 which the first light beam LBA emitted from the first semiconductor laser 110 directly enters, and a prism 136 which the second light beam LBB emitted from the second semiconductor laser 120 directly enters.

The prism 136 has a plane of incidence 138 which the second light beam LBB enters, a reflecting surface 137 which reflects nearly 100% of the second light beam LBB toward the polarization beam splitter 131, and an exit surface 139 from which the second light beam LBB is emitted. The reflecting surface 137 is an unprocessed surface when conditions for total reflection are satisfied, or is provided with a reflective coat when the conditions for total reflection are not satisfied.

The polarization beam splitter 131 has a first plane of incidence 132 which the first light beam LBA enters, a second plane of incidence 135 which the second light beam LBB enters, a bonding surface 134 which transmits nearly 100% of the first light beam LBA and reflects nearly 100% of the second light beam LBB, and an exit surface 133 from which the first light beam LBA and the second light beam LBB are emitted.

The prism 136 is arranged adjacent to the polarization beam splitter 131. In detail, the prism 136 and the polarization beam splitter 131 are arranged so that the exit surface 139 of the prism 136 and the polarization beam splitter 131 have plane contact with each other.

Further, the light beam combining element 130 has a ½ wave plate 146 disposed on the plane of incidence 138 of the prism 136, and a ¼ wave plate 141 disposed on the exit surface 133 of the polarization beam splitter 131.

The first light beam LBA emitted by the first semiconductor laser 110 and the second light beam LBB emitted by the second semiconductor laser 120 are both light beams of linearly-polarized light. The polarization direction of the first light beam LBA and the polarization direction of the second light beam LBB coincide with each other. For example, the polarization direction of the first light beam LBA and the polarization direction of the second light beam LBB are parallel to the x axis. In other words, the first semiconductor laser 110 and the second semiconductor laser 120 both emit the light beams of P-polarized light to the bonding surface 134 of the polarization beam splitter 131.

The ray axis of the ¼ wave plate 141 is set so as to convert P-polarized light and S-polarized light into circularly-polarized light. In other words, the ray axis of the ¼ wave plate 141 is set to 45 degrees with respect to the polarization directions of the P-polarized light and the S-polarized light.

The ray axis of the ½ wave plate 146 is set so as to convert the P-polarized light into the S-polarized light. The first light beam LBA which is emitted from the first semiconductor laser 110, and which is the P-polarized light of diverging light enters the polarization beam splitter 131 from the first plane of incidence 132, and then nearly 100% of the first light beam LBA which entered the polarization beam splitter 131 is transmitted through the bonding surface 134 to be emitted from the exit surface 133. The first light beam LBA of the P-polarized light emitted from the polarization beam splitter 131 passes through the ¼ wave plate 141 to thereby be converted into a light beam of circularly-polarized light. Subsequently, the first light beam LBA of diverging light passes through the collimator lens 31 to thereby be converted into a light beam of substantially parallel light.

The second light beam LBB which is emitted from the second semiconductor laser 120, and which is the P-polarized light of diverging light enters the ½ wave plate 146, and then passes through the ½ wave plate 146 to thereby be converted into a light beam of the S-polarized light. Subsequently, the second light beam LBB enters the prism 136 from the plane of incidence 138, and nearly 100% of the second light beam LBB which entered the prism 136 is then reflected by the reflecting surface 137 to be emitted from the exit surface 139. The second light beam LBB of the S-polarized light emitted from the prism 136 enters the polarization beam splitter 131 from the second plane of incidence 135, and then nearly 100% of the second light beam LBB which entered the polarization beam splitter 131 is then reflected by the bonding surface 134 to be emitted from the exit surface 133. The second light beam LBB of the S-polarized light emitted from the polarization beam splitter 131 passes through the ¼ wave plate to thereby be converted into a light beam of circularly-polarized light. Subsequently, the second light beam LBB of diverging light passes through the collimator lens 31 to thereby be converted into a light beam of substantially parallel light.

It should be noted that the reason that the first light beam LBA of the P-polarized light is converted by the ¼ wave plate 141 into the light beam of the circularly-polarized light, and the second light beam LBB of the S-polarized light is converted by the ¼ wave plate 141 into the light beam of the circularly-polarized light is for homogenizing transmission characteristics and the reflection characteristics of the first light beam LBA and the second light beam LBB in optical components (the polygon mirror 35, the fθ lens 37, the holding mirror 38, and the cover glass) of the optical system of the optical scanning device 30 located downstream of the ¼ wave plate 141.

The first light beam LBA and the second light beam LBB are combined with each other by the bonding surface 134 of the polarization beam splitter 131, and then pass through the collimator lens 31 to thereby form a light beam LB of parallel light. The light beam LB proceeds along the optical axis LA of the optical system of the optical scanning device 30, and is converged on the image plane IP at a finite focus. The image plane IP is a surface of the photo conductor included in the developing unit 22. In FIG. 9, the optical axis LA of the optical system of the optical scanning device 30 is drawn with a straight line for the sake of convenience.

### (Air Conversion Length)

Then, the light source module 100 will be described in further detail with reference to FIG. 9. In the light source module 100, the first light emitting surface 112 of the first LD chip 111 of the first semiconductor laser 110 and the second light emitting surface 122 of the second LD chip 121 of the second semiconductor laser 120 are both substantially located on the same plane EP.

In the configuration in which the first semiconductor laser 110 and the second semiconductor laser 120 are arranged so that the first light emitting surface 112 and the second light emitting surface 122 are substantially located on the same plane EP as described above, when the polarization beam splitter 131 and the anterior components are in the same medium (e.g., air), since a back focus position of the collimator lens 31 dramatically is different between the first semiconductor laser 110 and the second semiconductor laser 120, a problem that images are not formed on the same image plane IP arises.

In order to avoid this problem, in the embodiment, the back focus position of the collimator lens 31 is uniformed between the first semiconductor laser 110 and the second semiconductor laser 120 in the state in which the first semiconductor laser 110 and the second semiconductor laser 120 are arranged so that the first light emitting surface 112 and the second light emitting surface 122 are substantially located on the same plane EP.

Therefore, in the light source module 100, an air conversion length of a total distance from the first light emitting surface 112 of the first LD chip 111 of the first semiconductor laser 110 to the exit surface 133 of the light beam combining element 130, and an air conversion length of a total distance from the second light emitting surface 122 of the second LD chip 121 of the second semiconductor laser 120 to the exit surface 133 of the light beam combining element 130 are equal to each other. The details will hereinafter be descried.

As illustrated in FIG. 9, a distance from the light emitting surface 112 of the first semiconductor laser 110 to the first plane of incidence 132 of the polarization beam splitter 131 of the light beam combining element 130 is defined as La. A distance on the light axis LAA from the first plane of incidence 132 to the bonding surface 134 of the polarization beam splitter 131 is defined as Lf. Further, a distance on the light axis LAA from the bonding surface 134 to the exit surface 133 of the polarization beam splitter 131 is defined as Lf. The thickness of the ¼ wave plate 141 is defined as Lg.

Further, a distance from the light emitting surface 112 of the second semiconductor laser 120 to a plane of incidence 147 of the ½ wave plate 146 of the light beam combining element 130 is defined as Lb. The thickness of the ½ wave plate 146 is defined as Lc. A distance on the light axis LAB from the plane of incidence 138 to the reflecting surface 137 of the prism 136 of the light beam combining element 130 is defined as Ld. A distance on the light axis LAB from the reflecting surface 137 to the exit surface 139 of the prism 136 is defined as Le. It should be noted that the light axis LAB is folded by 90 degrees by the reflecting surface 137. Further, the exit surface 139 of the prism 136 coincides with the second plane of incidence 135 of the polarization beam splitter 131 of the light beam combining element 130. A distance on the light axis LAB from the second plane of incidence 135 to the bonding surface 134 of the polarization beam splitter 131 is defined as Lf.

Further, the refractive index of the ½ wave plate 146 and the ¼ wave plate 141 is defined as na, the refractive index of the prism 136 is defined as nb, and the refractive index of the polarization beam splitter 131 is defined as nc.

Defocusing Δα due to the ½ wave plate 146 is expressed by Formula (1) described below.

$$Δα = Lc \times ( 1 - 1 / na ) \qquad ( 1 )$$

Defocusing AB due to the prism 136 is expressed by Formula (2) described below.

$$Δβ = ( Ld + Le ) \times ( 1 - 1 / nb ) \qquad ( 2 )$$

Conditions for the first light emitting surface 112 of the first semiconductor laser 110 and the second light emitting surface 122 of the second semiconductor laser 120 to substantially be located on the same plane EP are expressed by Formula (3) and Formula (4) described below.

$$Lb + Lc + Ld + Le = La + Δα + Δβ \qquad ( 3 )$$

$$La + Lf = Lb + Lc + Ld \qquad ( 4 )$$

Formula (5) described below is obtained from Formula (1), Formula (2), Formula (3), and Formula (4).

$$Ld = ( Lf - Lc ( 1 - 1 / na ) + Le / nb ) / ( 1 - 1 / nb ) \qquad ( 5 )$$

Further, by modifying Formula (4), Formula (6) described below is obtained.

$$Lb = La + Lf - Lc - Ld \qquad ( 6 )$$

La is set so that Lb takes a positive value.

As a calculation example, when assuming La=12, Lc=0.5, Le=3.5, Lf=5, na=1.52, and nb=1.83, Ld=14.864 and Lb=1.636 are obtained.

By setting the parameters so as to satisfy the conditions described above, even in the configuration in which the first semiconductor laser 110 and the second semiconductor laser 120 are arranged so that the first light emitting surface 112 and the second light emitting surface 122 are substantially located on the same plane EP, the first light beam LBA emitted from the first light emitting surface 112 and the second light beam LBB emitted from the second light emitting surface 122 can be made to be combined with each other by the light beam combining element 130, and then form images on the same image plane IP after being transmitted through the common collimator lens 31.

Meanwhile, (air conversion length)=(thickness)/(refractive index at that thickness) is defined. The air conversion length from the first light emitting surface 112 of the first semiconductor laser 110 to an exit surface 143 of the ¼ wave plate 141 of the light beam combining element 130 is defined as an air conversion length S1 at the first semiconductor laser 110 side. Further, the air conversion length from the second light emitting surface 122 of the second semiconductor laser 120 to the exit surface 143 of the ¼ wave plate 141 of the light beam combining element 130 is defined as an air conversion length S2 at the second semiconductor laser 120 side. Further, Lg=0.5 and nc=1.52 are assumed.

The air conversion length S1 at the first semiconductor laser 110 side is expressed by Formula (7) described below.

$$S 1 = La / 1 + Lf / nc + Lf / nc + Lg / na \qquad ( 7 )$$

The air conversion length S2 at the second semiconductor laser 120 side is expressed by Formula (8) described below.

$$S 2 = Lb / 1 + Lc / na + Ld / nb + Le / nb + Lf / nc + Lf / nc + Lg / na \qquad ( 8 )$$

By substituting the numerical values in the calculation example described above in Formula (7), S1=18.907 is obtained.

By substituting the numerical values in the calculation example described above in Formula (8), S2=18.907 is obtained.

As described above, S1=S2 is achieved. In other words, by making the air conversion length S1 from the first light emitting surface 112 of the first semiconductor laser 110 to the exit surface 143 of the ¼ wave plate 141 of the light beam combining element 130 and the air conversion length S2 from the second light emitting surface 122 of the second semiconductor laser 120 to the exit surface 143 of the ¼ wave plate 141 of the light beam combining element 130 equal to each other, rewording that “even in the configuration in which the first semiconductor laser 110 and the second semiconductor laser 120 are arranged so that the first light emitting surface 112 and the second light emitting surface 122 are substantially located on the same plane EP, the first light beam LBA emitted from the first light emitting surface 112 and the second light beam LBB emitted from the second light emitting surface 122 can be made to be combined with each other by the light beam combining element 130, and then form the images on the same image plane IP after being transmitted through the common collimator lens 31” is possible.

Further, due to Formula (7) and Formula (8), Formula (9) as a relational expression described below can be derived.

$$S 1 - S 2 = La - Lb - Lc / na - Ld / nb - Le / nb \qquad ( 9 )$$

By substituting Formula (5) and Formula (6) into Formula (9), Formula (10) described below is obtained.

$$S 1 - S 2 = 0 \qquad ( 10 )$$

In other words, S1=S2 is obtained. It should be noted that formula manipulation software such as Mathematica (registered trademark) is used for deriving Formula (9) and calculating Formula (10).

### First Practical Example

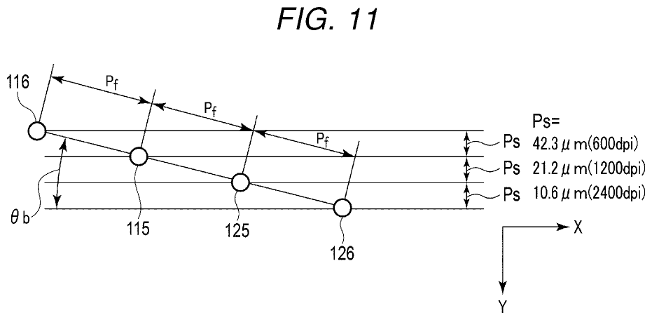

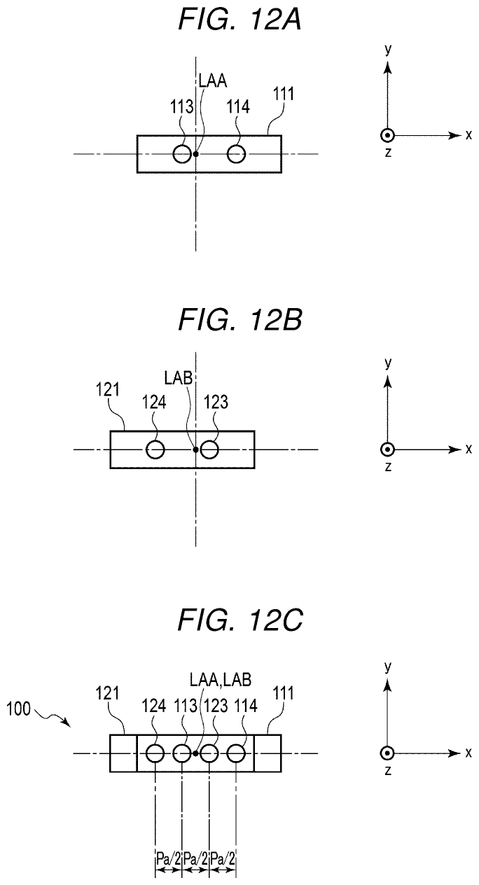

The light source module 100 according to a first practical example will be described with reference to FIG. 10A through FIG. 10E and FIG. 11.

FIG. 10A through FIG. 10C are diagrams schematically illustrating the light source module 100 according to the first practical example. In the first practical example, the LD chips 111, 112 of the semiconductor lasers 110, 120 each have a two beam array. A view from an A direction of the first LD chip 111 is illustrated in FIG. 10A, and a view from a B direction of the second LD chip 121 is illustrated in FIG. 10B. FIG. 10C illustrates a diagram showing the first LD chip 111 illustrated in FIG. 10A and the second LD chip 121 illustrated in FIG. 10B so as to overlap each other at the light axes LAA, LAB. FIG. 10D illustrates the optical system of the optical scanning device 30 in a simplified manner similarly to FIG. 9. A light path between the first LD chip 111 and the collimator lens 31 and a light path between the second LD chip 121 and the collimator lens 31 are described in a state of being converted into the air conversion lengths. FIG. 10E illustrates a plan view showing four converging spots 115, 116, 125, 126 formed on the image plane IP with the light beams emitted by the two LD chips 111, 121 illustrated in FIG. 10C.

In the light source module 100 according to the first practical example, two light emitting units 113, 114 of the first LD chip 111 are arranged side by side on a straight line in parallel to the x axis, and two light emitting units 123, 124 of the second LD chip 121 are also arranged side by side on a straight line in parallel to the x axis. A distance along the x axis between the two light emitting units 113, 1114 of the first LD chip 111 and a distance along the x axis between the two light emitting units 123, 124 of the second LD chip 121 are both Pa. Further, a distance along the x axis between the light emitting unit 113 at inner side of the first LD chip 111 and the light emitting unit 123 at inner side of the second LD chip 121 is also Pa. In other words, regarding the x direction, the four light emitting units 113, 114, 123, and 124 of the two LD chips 111, 121 are arranged side by side at equal distances Pa.

The light axis LAA of the first LD chip 111 passes through an intersection of a straight line passing through the centers of the light emitting units 113, 114, and a straight line which divides the distance in the x direction between the center of the light emitting unit 113 at the inner side of the first LD chip 111 and the center of the light emitting unit 123 at the inner side of the second LD chip 121 into two equal distances, and which is parallel to the y axis. The light axis LAB of the second LD chip 121 passes through an intersection of a straight line passing through the centers of the light emitting units 123, 124, and a straight line which divides the distance in the x direction between the center of the light emitting unit 113 at the inner side of the first LD chip 111 and the center of the light emitting unit 123 at the inner side of the second LD chip 121 into two equal distances, and which is parallel to the y axis.

The four light beams emitted from the two LD chips 111, 121 are converged on the image plane IP by the optical system of the optical scanning device 30 including the collimator lens 31 to form the four converging spots 115, 116, 125, and 126. The four converging spots 115, 116, 125, and 126 are arranged on a straight line in parallel to the X axis. The distances along the X axis of the four converging spots 115, 116, 125, and 126 are all Pe. The optical axis LA passes through a point which divides a distance between the center of the converging spot 115 and the center of the converging spot 125 into two equal distances. In other words, the optical axis LA passes through a centroid of the four converging spots 115, 116, 125, and 126.

FIG. 11 illustrates a plan view showing the four converging spots 115, 116, 125, and 126 actually formed on the image plane IP with the two light beams LBA, LBB emitted by the light source module 100 according to the first practical example fixed to the housing 40 after an angle adjustment. The distances of the four converging spots 115, 116, 125, and 126 are all Pf. Here, the reason that Pf does not coincide with Pe is that in the case of an optical scanning system, the magnification of the optical system is different between the main scanning direction (the X direction) and the sub-scanning direction (the Y direction) in some cases.

In the light source module 100, the angle adjustment is performed around the light axis LAA when fixing the light source module 100 to the housing 40. The straight line passing through the centers of the four converging spots 115, 116, 125, and 126 is adjusted so as to form an angle of Ob with the main scanning direction, namely the X direction. In one example, Ob represents an angle at which adjacent two of the four converging spots 115, 116, 125, and 126 are shifted from each other in the Y direction by Ps in order to obtain a desired resolution in the sub-scanning direction. Ps is 42.3 μm when the resolution is 600 dpi, 21.2 μm when the resolution is 1200 dpi, or 10.6 μm when the resolution is 2400 dpi.

In order to obtain such an arrangement of the converging spots 115, 116, 125, and 126, when fixing the light source module 100 to the housing 40, the angle of the light source module around the light axis is adjusted so that the arrangement of the converging spots 115, 116, 125, and 126 illustrated in FIG. 11 is obtained, and then, the light source module 100 is fixed to the housing 40 with a measure such as bonding or screwing.

### Second Practical Example

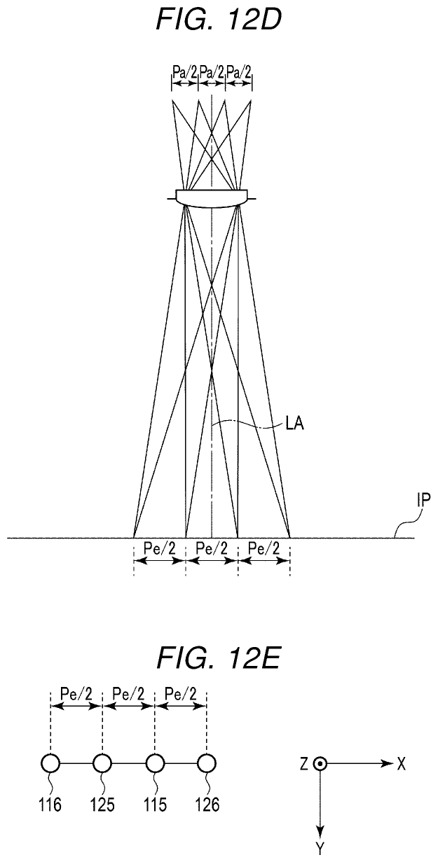

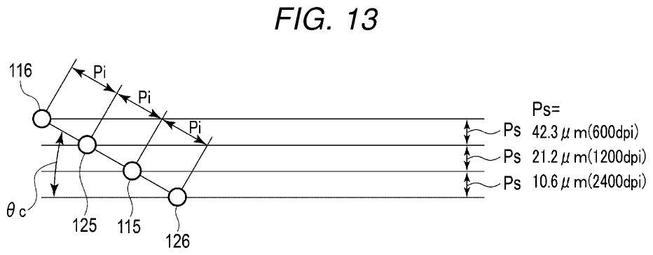

Then, the light source module 100 according to a second practical example will be described with reference to FIG. 12A through FIG. 12E and FIG. 13. The second practical example is obtained by deforming the layout on the x-y plane of the first LD chip 111 of the first semiconductor laser 110 and the second LD chip 121 of the second semiconductor laser 120 similarly to the first practical example.

FIG. 12A through FIG. 12E and FIG. 13 related to the second practical example correspond respectively to FIG. 10A through FIG. 10E and FIG. 11 related to the first practical example. Therefore, the meanings of FIG. 12A through FIG. 12E and FIG. 13 substantially the same respectively as FIG. 10A through FIG. 10E and FIG. 11. In order to avoid redundant description, the description will hereinafter be presented with a focus on different portions from the first practical example.

In the light source module 100 according to the second practical example, the two light emitting units 113, 114 of the first LD chip 111 are arranged side by side on a straight line in parallel to the x axis, and the two light emitting units 123, 124 of the second LD chip 121 are also arranged side by side on a straight line in parallel to the x axis. A distance along the x axis between the two light emitting units 113, 1114 of the first LD chip 111 and a distance along the x axis between the two light emitting units 123, 124 of the second LD chip 121 are both Pa. In the above points, the light source module 100 according to the second practical example is substantially the same as the light source module 100 according to the first practical example.

In the light source module 100 according to the second practical example, the light emitting unit 113 at the inner side of the first LD chip 111 is arranged at a position which divides a distance between the centers of the two light emitting units 123, 124 of the second LD chip 121 into two equal distances with respect to the x direction. Further, the light emitting unit 123 at the inner side of the second LD chip 121 is arranged at a position which divides a distance between the centers of the two light emitting units 113, 114 of the first LD chip 111 into two equal distances with respect to the x direction. In other words, the four light emitting units 113, 114, 123, and 124 of the two LD chips 111, 121 are arranged side by side at equal distances Pa/2 along the x axis.

The light axis LAA of the first LD chip 111 passes through the intersection of the straight line passing through the centers of the light emitting units 113, 114, and the straight line which divides the distance in the x direction between the center of the light emitting unit 113 at the inner side of the first LD chip 111 and the center of the light emitting unit 123 at the inner side of the second LD chip 121 into two equal distances, and which is parallel to the y axis. The light axis LAB of the second LD chip 121 passes through the intersection of the straight line passing through the centers of the light emitting units 123, 124, and the straight line which divides the distance in the x direction between the center of the light emitting unit 113 at the inner side of the first LD chip 111 and the center of the light emitting unit 123 at the inner side of the second LD chip 121 into two equal distances, and which is parallel to the y axis.

Similarly to the first practical example, the four light beams emitted from the two LD chips 111, 121 are converged on the image plane IP by the optical system of the optical scanning device 30 including the collimator lens 31 to form the four converging spots 115, 116, 125, and 126. The four converging spots 115, 116, 125, and 126 are arranged on a straight line in parallel to the X axis. It should be noted that in the second practical example, the distances along the X axis of the four converging spots 115, 116, 125, and 126 are all Pe/2. The optical axis LA passes through the point which divides the distance between the center of the converging spot 115 and the center of the converging spot 125 into two equal distances. In other words, the optical axis LA passes through the centroid of the four converging spots 115, 116, 125, and 126.

FIG. 13 illustrates a plan view showing the four converging spots 115, 116, 125, and 126 actually formed on the image plane IP with the two light beams LBA, LBB emitted by the light source module 100 according to the second practical example fixed to the housing 40 after the angle adjustment. This corresponds to FIG. 11. The distances of the four converging spots 115, 116, 125, and 126 are all Pi. Pi approximates Pf/2.

As described above, in the light source module 100, the angle adjustment is performed around the light axis LAA when fixing the light source module 100 to the housing 40. The straight line passing through the centers of the four converging spots 115, 116, 125, and 126 is adjusted so as to form an angle of θc with the main scanning direction, namely the X direction. The displacement in the Y direction between adjacent two of the converging spots 115, 116, 125, and 126 is substantially the same as in the first practical example.

In the second practical example, as illustrated in FIG. 12C, the four light emitting units 113, 114, 123, and 124 are arranged side by side at distances Pe/2 a half as large as the distances in the first practical example with respect to the x direction. Therefore, as is understood from the comparison between FIG. 11 and FIG. 13, the angle θc at which the light source module 100 is rotated for obtaining the same resolution in the sub-scanning direction is nearly twice as large as the angle θb. Therefore, compared to the first practical example, in the second practical example, the sensitivity in the angle adjustment of the light source module 100 is lower. Therefore, the adjustment of the resolution in the sub-scanning direction is easy to perform. In other words, a dramatic shift in the resolution in the sub-scanning direction with a small change in angle is prevented.

### (Advantages)

In the light source module 100 according to the embodiment, the air conversion length of the total distance from the first light emitting surface 112 of the first LD chip 111 of the first semiconductor laser 110 to the exit surface 143 of the ¼ wave plate 141 of the light beam combining element 130, and the air conversion length of the total distance from the second light emitting surface 122 of the second LD chip 121 of the second semiconductor laser 120 to the exit surface 143 of the ¼ wave plate 141 of the light beam combining element 130 are equal to each other. Therefore, the light source module 100 is capable of mounting the first semiconductor laser 110 and the second semiconductor laser 120 on the same substrate 170, and at the same time, combining the light beam LBA emitted by the first semiconductor laser 110 and the light beam LBB emitted by the second semiconductor laser 120 with each other before entering the collimator lens 31 to be focused on the same image plane IP.

Although some embodiments are described, these embodiments are illustrative only, but limiting the scope of the disclosure is not intended. These novel embodiments can be implemented with other various aspects, and a variety of omissions, replacements, and modifications can be made within the scope or the spirit of the disclosure. These embodiments and the modifications thereof are included in the scope of the disclosure, and at the same time, included in the disclosure set forth in the appended claims and the equivalents thereof.

What is claimed is:

1. A light source module, comprising:
a first semiconductor laser and a second semiconductor laser arranged so that respective light axes are parallel to each other; and
a light beam combining element in which a first light beam and a second light beam respectively emitted by the first semiconductor laser and the second semiconductor laser enter, the light beam combining element configured to emit the first light beam and the second light beam with respective light axes made closer to each other, wherein
an air conversion length of a first total distance from a first light emitting surface of the first semiconductor laser to an exit surface of the light beam combining element, and an air conversion length of a second total distance from a second light emitting surface of the second semiconductor laser to the exit surface of the light beam combining element are equal to each other.

2. The light source module according to claim 1, wherein
the light beam combining element comprises a polarization beam splitter in which the first light beam directly enters, and a prism which is arranged adjacent to the polarization beam splitter, and in which the second light beam directly enters, the prism configured to reflect the second light beam toward the polarization beam splitter, and the polarization beam splitter configured to transmit the first light beam, and to reflect the second light beam.

3. The light source module according to claim 2, wherein
the first light beam and the second light beam are linearly-polarized light beams which coincide in polarization direction with each other, and
the light beam combining element further comprises a ½ wave plate disposed on a plane of incidence of the prism.

4. The light source module according to claim 3, wherein
the first semiconductor laser and the second semiconductor laser emit the light beams of a P-polarized first light beam and a P-polarized second light beam to a bonding surface of the polarization beam splitter.

5. The light source module according to claim 3, wherein
a ray axis of the ½ wave plate is set so as to convert the P-polarized light into the S-polarized light.

6. The light source module according to claim 3, wherein
the light beam combining element has a ¼ wave plate disposed on an exit surface of the polarization beam splitter.

7. The light source module according to claim 1, wherein
the first light emitting surface of the first semiconductor laser and the second light emitting surface of the second semiconductor laser are located on a same plane.

8. A light processing method, comprising:
arranging respective light axes of a first semiconductor laser and a second semiconductor laser are parallel to each other;
directing a first light beam and a second light beam respectively emitted by the first semiconductor laser and the second semiconductor laser to enter a light beam combining element; and
emitting the first light beam and the second light beam with respective light axes made closer to each other by the light beam combining element from the light beam combining element, wherein
an air conversion length of a first total distance from a first light emitting surface of the first semiconductor laser to an exit surface of the light beam combining element, and an air conversion length of a second total distance from a second light emitting surface of the second semiconductor laser to the exit surface of the light beam combining element are equal to each other.

9. The light processing method according to claim 8, wherein
the light beam combining element comprises a polarization beam splitter in which the first light beam directly enters, and a prism which is arranged adjacent to the polarization beam splitter, and in which the second light beam directly enters, the prism configured to reflect the second light beam toward the polarization beam splitter, and the polarization beam splitter configured to transmit the first light beam, and to reflect the second light beam.

10. The light processing method according to claim 9, wherein
the first light beam and the second light beam are linearly-polarized light beams which coincide in polarization direction with each other, and
the light beam combining element further comprises a ½ wave plate disposed on a plane of incidence of the prism.

11. The light processing method according to claim 10, wherein
the first semiconductor laser and second the semiconductor laser emit the light beams of a P-polarized first light beam and a P-polarized second light beam to a bonding surface of the polarization beam splitter.

12. The light processing method according to claim 10, wherein
a ray axis of the ½ wave plate is set so as to convert the P-polarized light into the S-polarized light.

13. The light processing method according to claim 10, wherein
the light beam combining element has a ¼ wave plate disposed on an exit surface of the polarization beam splitter.

14. An image forming device, comprising:
a light source module, comprising:
a first semiconductor laser and second semiconductor laser arranged so that respective light axes are parallel to each other; and
a light beam combining element in which a first light beam and a second light beam respectively emitted by the first semiconductor laser and the second semiconductor laser enter, the light beam combining element configured to emit the first light beam and the second light beam with respective light axes made closer to each other, wherein
an air conversion length of a first total distance from a first light emitting surface of the first semiconductor laser to an exit surface of the light beam combining element, and an air conversion length of a second total distance from a second light emitting surface of the second semiconductor laser to the exit surface of the light beam combining element are equal to each other.

15. The image forming device according to claim 14, wherein
the light beam combining element comprises a polarization beam splitter in which the first light beam directly enters, and a prism which is arranged adjacent to the polarization beam splitter, and in which the second light beam directly enters, the prism configured to reflect the second light beam toward the polarization beam splitter, and the polarization beam splitter configured to transmit the first light beam, and to reflect the second light beam.

16. The image forming device according to claim 15, wherein
the first light beam and the second light beam are linearly-polarized light beams which coincide in polarization direction with each other, and
the light beam combining element further comprises a ½ wave plate disposed on a plane of incidence of the prism.

17. The image forming device according to claim 16, wherein
the first semiconductor laser and the second semiconductor laser emit the light beams of a P-polarized first light beam and a P-polarized second light beam to a bonding surface of the polarization beam splitter.

18. The image forming device according to claim 16, wherein
a ray axis of the ½ wave plate is set so as to convert the P-polarized light into the S-polarized light.

19. The image forming device according to claim 16, wherein
the light beam combining element has a ¼ wave plate disposed on an exit surface of the polarization beam splitter.

20. The image forming device according to claim 14, wherein
the first light emitting surface of the first semiconductor laser and the second light emitting surface of the second semiconductor laser are located on a same plane.
